(19) United States
(12) Patent Application Publication
(10) Pub. No.: US 2012/0188161 A1
(43) Pub. Date: Jul. 26, 2012

(54) MOUSE

(76) Inventors: Po-Jen SHIH, Taipei Hsien (TW); Shu-I Chen, Taipei Hsien (TW)

(21) Appl. No.: 13/014,134

(22) Filed: Jan. 26, 2011

(51) Int. Cl. G06F 3/033

(52) U.S. Cl. 345/163

(57) ABSTRACT

A mouse adapted to stand or lie on a supporting surface is provided. The mouse includes a housing, a power source and a power switch unit. The power source is disposed in the housing. The power switch unit is disposed in the housing, and includes a pivot shaft, a weight element and a switch circuit board. The weight element pivots on the pivot shaft, wherein the weight element pivots between a first orientation and a second orientation. The switch circuit board is electrically connected to the power source, wherein the switch circuit board includes a first contact and a second contact, and when the weight element is in the second orientation, the weight element electrically connects the first contact to the second contact, and when the weight element is in the first orientation, the weight element is separated from the first contact and the second contact.

### BACKGROUND OF THE INVENTION

1. Field of the Invention

The present invention relates to a mouse, and in particular relates to a wireless mouse which has decreased power consumption.

2. Description of the Related Art

A conventional wireless mouse is automatically deactivated only when the key of the wireless mouse has not been pressed for a long period of time. Thus, a relatively large amount of power is consumed during the long period of time, shortening the time for battery power usage of the wireless mouse. Therefore, a wireless mouse with decreased power consumption is required.

### BRIEF SUMMARY OF THE INVENTION

A mouse adapted to stand or lie on a supporting surface is provided. The mouse includes a housing, a power source and a power switch unit. The power source is disposed in the housing. The power switch unit is disposed in the housing, the power switch unit includes a pivot shaft, a weight element and a switch circuit board. The weight element pivots on the pivot shaft, wherein the weight element pivots between a first orientation and a second orientation, and when the mouse is placed standing on the supporting surface, the weight element is in the first orientation, and when the mouse lies on the supporting surface, the weight element is in the second orientation. The switch circuit board is electrically connected to the power source, wherein the switch circuit board comprises a first contact and a second contact, and when the weight element is in the second orientation, the weight element electrically connects the first contact to the second contact to turn on the mouse, and when the weight element is in the first orientation, the weight element is separated from the first contact and the second contact.

When utilizing the mouse of the embodiments of the invention, the power switch unit turns off the mouse automatically when the mouse is placed standing on a supporting surface. Accordingly, power consumption of the power source (battery unit) of the mouse is saved, and battery power usage of the mouse is extended.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A shows a mouse of a first embodiment of the invention standing on a supporting surface (table);

FIG. 1B shows the mouse of the first embodiment of the invention lying on the supporting surface (table);

FIG. 2A is a sectional view of the mouse in FIG. 1A;

FIG. 2B is a sectional view of the mouse in FIG. 1B;

FIG. 3 shows a detailed structure of a switch circuit board of the first embodiment of the invention;

FIG. 4 is a block diagram of the mouse of the first embodiment of the invention;

FIGS. 5A and 5B show a mouse of a second embodiment of the invention;

FIGS. 6A and 6B show a mouse of a third embodiment of the invention; and

FIG. 7 shows a mouse of a fourth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

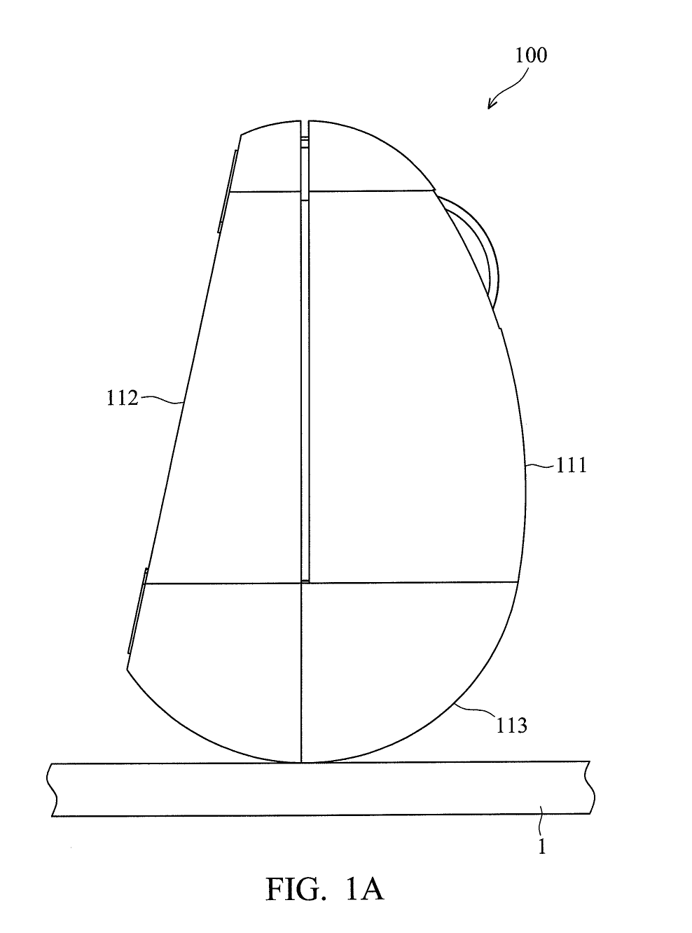

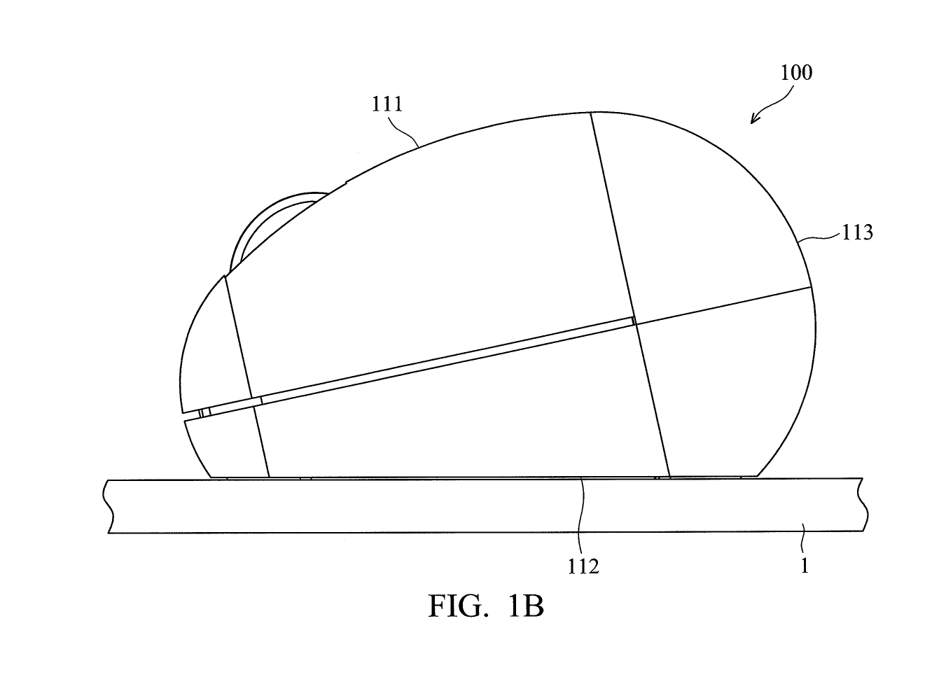

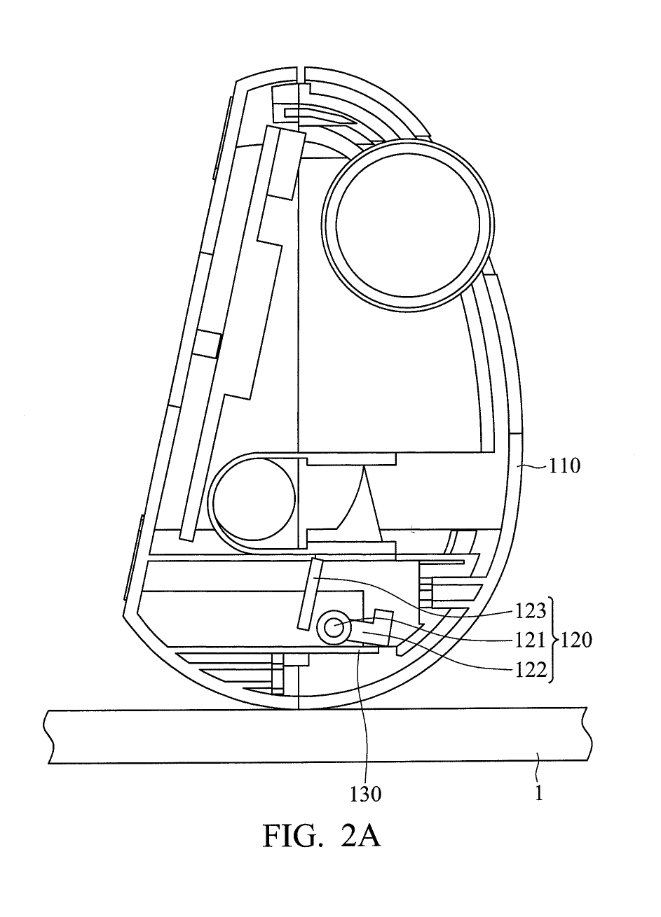

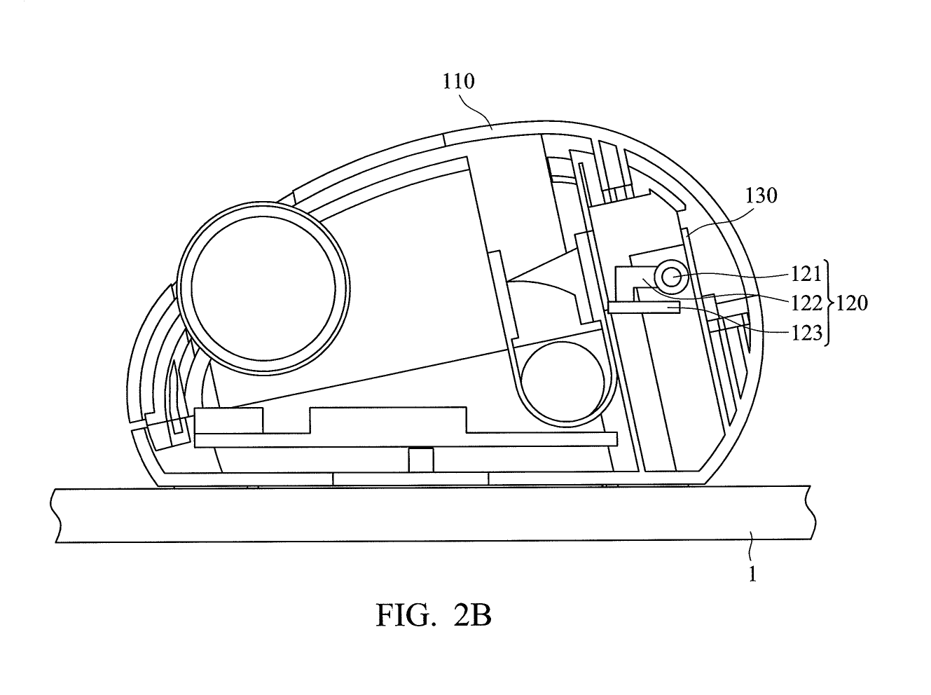

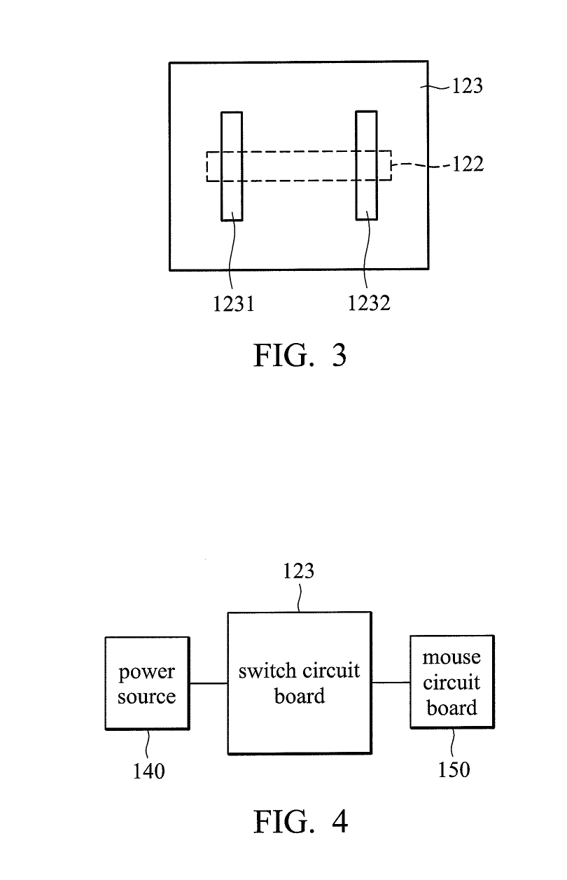

FIGS. 1A and 1B show a mouse 100 of a first embodiment of the invention. FIG. 1A shows the mouse 100 of the first embodiment standing on a supporting surface (table). FIG. 1B shows the mouse 100 of the first embodiment lying on the supporting surface (table). FIG. 2A is a sectional view of the mouse 100 in FIG. 1A. FIG. 2B is a sectional view of the mouse 100 in FIG. 1B. With reference to FIGS. 2A and 2B, the mouse 100 comprises a housing 110, a power source (not shown) and a power switch unit 120. The power source is disposed in the housing 110. The power switch unit 120 is disposed in the housing 110. The power switch unit 120 comprises a pivot shaft 121, a weight element 122 and switch circuit board 123. The weight element 122 pivots on the pivot shaft 121, wherein the weight element 122 pivots between a first orientation (as shown in FIG. 2A) and a second orientation (as shown in FIG. 2B). When the mouse 100 stands on the supporting surface, the weight element 122 is in the first orientation, and when the mouse 100 lies on the supporting surface, the weight element 122 pivots to the second orientation. The switch circuit board 123 is electrically connected to the power source. With reference to FIG. 3, the switch circuit board 123 comprises a first contact 1231 and a second contact 1232. When the weight element 122 is in the second orientation, the weight element 122 electrically connects the first contact 1231 to the second contact 1232 to turn on the mouse 100. In FIG. 3, the weight element 122 is shown as a dotted line. With reference to FIGS. 2A, 2B and 3, the weight element 122 is L shaped, an end of the weight element 122 pivots on the pivot shaft 121, and when the weight element 122 is in the second orientation, the other end of the weight element 122 contacts the first contact 1231 and the second contact 1232.

With reference to FIGS. 2A and 2B, the mouse 100 further comprises a barricade 130, wherein when the weight element 122 is in the first orientation, the weight element 122 abuts the barricade 130.

With reference to FIG. 4, the poured source 140 is electrically connected to the switch circuit board 123 of the power switch unit 120. The switch circuit board 123 is electrically connected to a mouse circuit board 150. When the mouse is turned on, the electric power provided by the power source 140 passes through the switch circuit board 123 to the mouse circuit board 150.

With reference to FIGS. 1A and 1B, the housing 110 further comprises a holding portion 111, a sliding portion 112 and a standing portion 113, wherein the standing portion 113 is connected to the holding portion 111 and the sliding portion 112, and the standing portion 113 is curved. In this embodiment, the center-of-gravity of the mouse 100 can be designed adjacent to the standing portion 113 to keep the mouse 100 standing similar to tumbler (toy). For example, the battery unit (power source) of the mouse 100 can be disposed in the housing 100 adjacent to the standing portion 113, or an additional weight can be disposed adjacent to the standing portion 113.

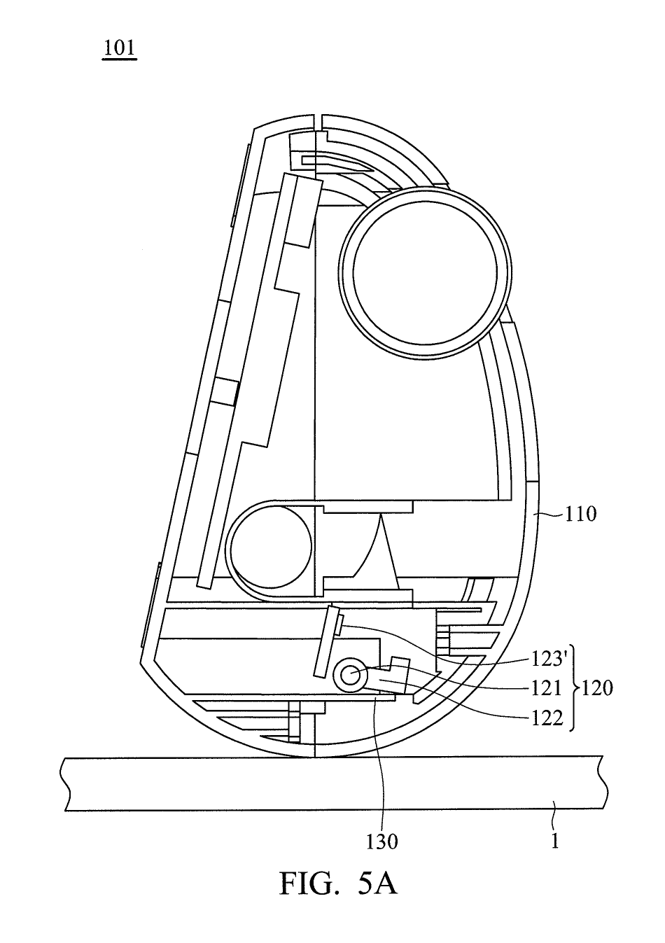

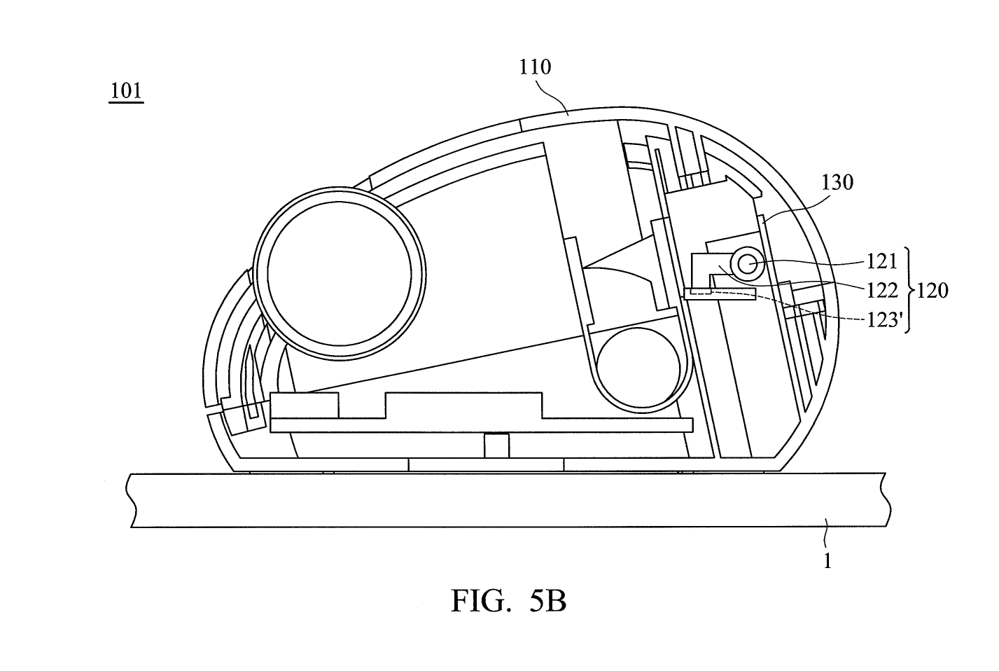

FIGS. 5A and 5B show a mouse 101 of a second embodiment of the invention, wherein the switch circuit board 123 is replaced by a switch element 123′. When the weight element 122 is in the second orientation, the weight element 122 presses the switch element 123′ to turn on the mouse. The switch element 123′ can be a contact switch or other switches.

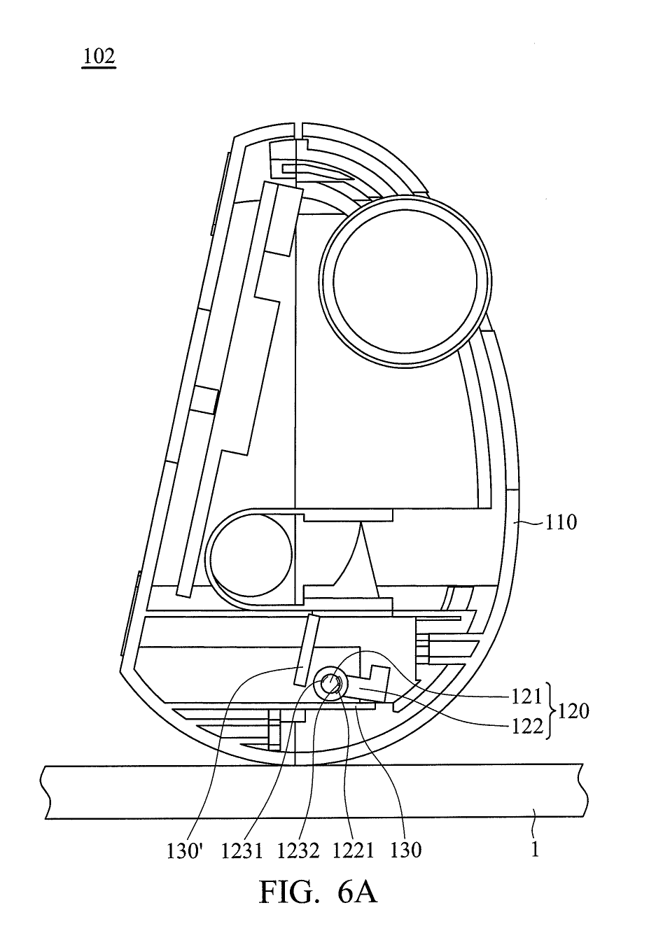

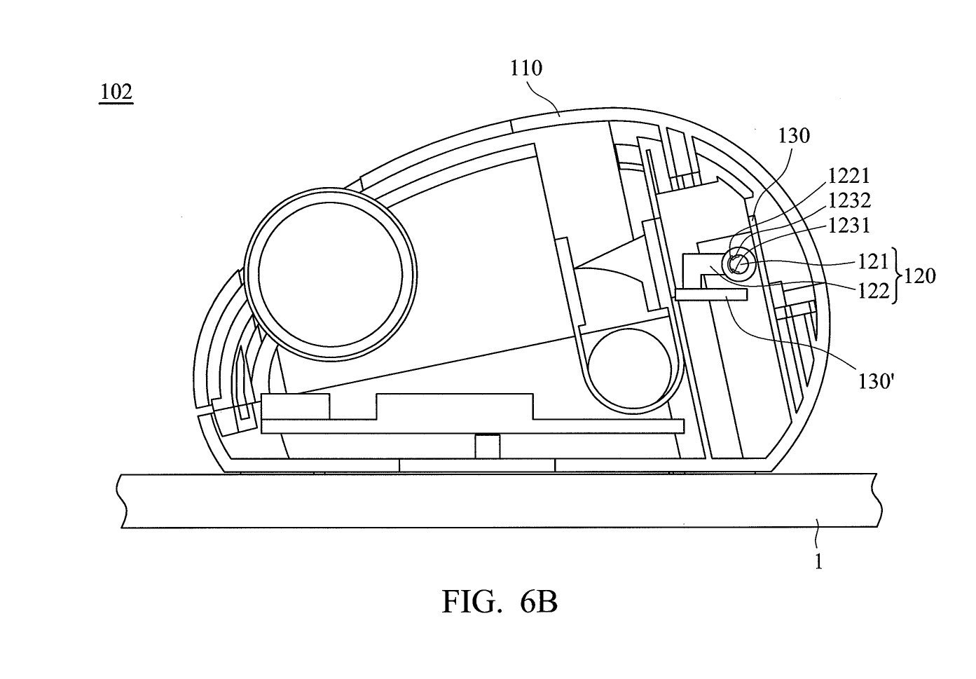

FIGS. 6A and 6B show a mouse 103 of a third embodiment of the invention, wherein the switch circuit board 123 is omitted. A first contact 1231 and a second contact 1232 are disposed on the pivot shaft 121. The weight element 122 comprises a conductive pad 1221. When the weight element 122 is in the second orientation, the conductive pad 1221 electrically connects the first contact 1231 to the second contact 1232 to turn on the mouse. Additionally, the mouse 102 of the third embodiment can further comprise a barricade 130′ to restrict the rotation orientation of the weight element 122.

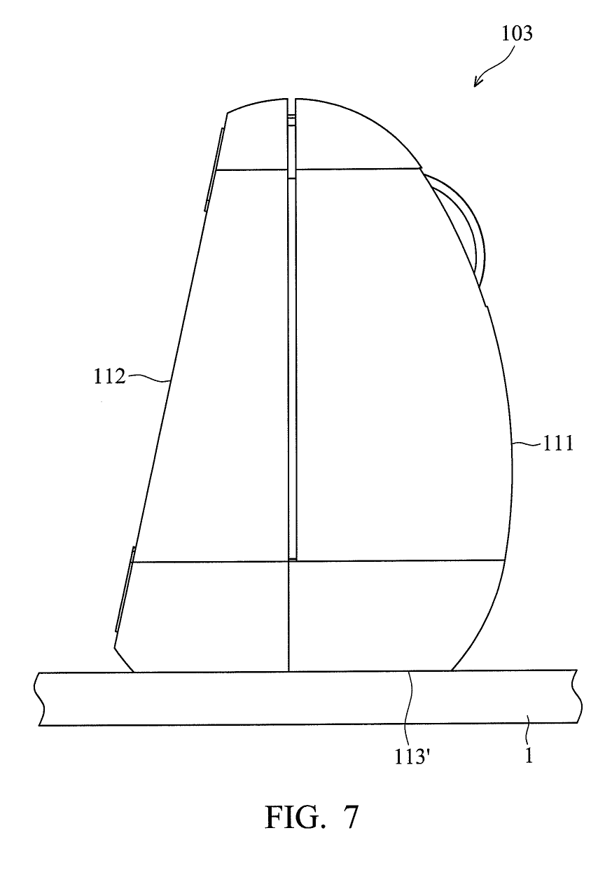

FIG. 7 shows a mouse 103 of a fourth embodiment of the invention, wherein the standing portion 113′ is planar, allowing the mouse 103 to stand therewith. The embodiment of FIG. 7 can be incorporated with any embodiment previously mentioned in this ?.

When utilizing the mouse of the embodiments of the invention, the power switch unit turns off the mouse automatically when the mouse is placed standing on the supporting surface. Accordingly, power consumption of the power source (battery unit) of the mouse is saved, and battery power usage of the mouse is extended.

The use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mouse adapted to stand or lie on a supporting surface, comprising:
a housing;
a power source, disposed in the housing; and
a power switch unit, disposed in the housing, comprising:
a pivot shaft;
a weight element, pivoting on the pivot shaft, wherein the weight element pivots between a first orientation and a second orientation, and when the mouse is placed standing on the supporting surface, the weight element is in the first orientation, and when the mouse lies on the supporting surface, the weight element is in the second orientation; and
a switch circuit board, electrically connected to the power source, wherein the switch circuit board comprises a first contact and a second contact, and when the weight element is in the second orientation, the weight element electrically connects the first contact to the second contact to turn on the mouse, and when the weight element is in the first orientation, the weight element is separated from the first contact and the second contact.

2. The mouse as claimed in claim 1, wherein the weight element is L shaped, and an end of the weight element pivots on the pivot shaft, and when the weight element is in the second orientation, the other end of the weight element contacts the first contact and the second contact.

3. The mouse as claimed in claim 1, further comprising a barricade, wherein when the weight element is in the first orientation, the weight element abuts the barricade.

4. The mouse as claimed in claim 1, wherein the housing further comprises a holding portion, a sliding portion and a standing portion, wherein the standing portion is connected to the holding portion and the sliding portion, and the standing portion is curved.

5. The mouse as claimed in claim 4, further comprising a battery unit, wherein the battery unit is disposed in the housing and is adjacent to the standing portion.

6. The mouse as claimed in claim 1, wherein the housing further comprises a holding portion, a sliding portion and a standing portion, and the standing portion is connected to the holding portion and the sliding portion, and the standing portion is planar.

7. A mouse adapted to stand or lie on a supporting surface, comprising:
a housing;
a power source, disposed in the housing; and
a power switch unit, disposed in the housing, comprising:
a pivot shaft;
a weight element, pivoting on the pivot shaft, wherein the weight element pivots between a first orientation and a second orientation, and when the mouse is placed standing on the supporting surface, the weight element is in the first orientation, and when the mouse lies on the supporting surface, the weight element is in the second orientation; and
a switch element, electrically connected to the power source, wherein when the weight element is in the second orientation, the weight element presses the switch element to turn on the mouse, and when the weight element is in the first orientation, the weight element is separated from the switch element.

8. The mouse as claimed in claim 7, wherein the weight element is L shaped, an end of the weight element pivots on the pivot shaft, and when the weight element is in the second orientation, the other end of the weight element presses the switch element.

9. The mouse as claimed in claim 7, further comprising a barricade, wherein when the weight element is in the first orientation, the weight element abuts the barricade.

10. The mouse as claimed in claim 7, wherein the housing further comprises a holding portion, a sliding portion and a standing portion, and the standing portion is connected to the holding portion and the sliding portion, and the standing portion is curved.

11. The mouse as claimed in claim 10, further comprising a battery unit, wherein the battery unit is disposed in the housing and is adjacent to the standing portion.

12. The mouse as claimed in claim 7, wherein the housing further comprises a holding portion, a sliding portion and a standing portion, and the standing portion is connected to the holding portion and the sliding portion, and the standing portion is planar.

13. A mouse adapted to stand or lie on a supporting surface, comprising:
a housing;
a power source, disposed in the housing; and
a power switch unit, disposed in the housing, comprising:
a pivot shaft;
a weight element, pivoting on the pivot shaft, wherein the weight element pivots between a first orientation and a second orientation, and when the mouse is placed standing on the supporting surface, the weight element is in the first orientation, and when the mouse lies on the supporting surface, the weight element is in the second orientation;
a first contact, disposed on the pivot shaft; and
a second contact, disposed on the pivot shaft, wherein when the weight element is in the second orientation, the weight element electrically connects the first contact to the second contact to turn on the mouse.

14. The mouse as claimed in claim 13, wherein the weight element is L shaped, an end of the weight element pivots on the pivot shaft, and the weight element comprises a conductive pad, and when the weight element is in the second orientation, the conductive pad electrically contacts the first contact to the second contact.

15. The mouse as claimed in claim 13, further comprising a barricade, wherein when the weight element is in the first orientation, the weight element abuts the barricade.

16. The mouse as claimed in claim 13, wherein the housing further comprises a holding portion, a sliding portion and a standing portion, and the standing portion is connected to the holding portion and the sliding portion, and the standing portion is curved.

17. The mouse as claimed in claim 16, further comprising a battery unit, wherein the battery unit is disposed in the housing and is adjacent to the standing portion.

18. The mouse as claimed in claim 13, wherein the housing further comprises a holding portion, a sliding portion and a standing portion, and the standing portion is connected to the holding portion and the sliding portion, and the standing portion is planar.
